(19) United States
(12) Patent Application Publication
(10) Pub. No.: US 2017/0129497 A1
(43) Pub. Date: May 11, 2017

(54) SYSTEM AND METHOD FOR ASSESSING USER ATTENTION WHILE DRIVING

(71) Applicant: PROJECT RAY LTD., Yokneam (IL)

(72) Inventors: Boaz ZILBERMAN, Ramat Hasharon (IL); Michael VAKULENKO, Zichron Yaakov (IL); Nimrod SANDLERMAN, Ramat-Gan (IL); Arik SIEGEL, Tzur Moshe (IL)

(73) Assignee: PROJECT RAY LTD., Yokneam (IL)

(21) Appl. No.: 15/102,184

(22) PCT Filed: Mar. 13, 2016
(86) PCT No.: PCT/IL2016/050271

§ 371 Date: Jun. 6, 2016

Related U.S. Application Data
(60) Provisional application No. 62/132,525, filed on Mar. 13, 2015.

(51) Int. Cl. B60W 40/08

(52) U.S. Cl. CPC B60W 40/08; G01S 19/13

(57) ABSTRACT

A method, a device, and a computer program defining a plurality of ambient conditions, associating a set of measurable ambient values for each of the ambient conditions, providing rules for computing a user attention requirement value based on the measurable ambient values, measuring one or more of the ambient conditions, and computing user attention requirement including the measured ambient values, using the rules.

### FIELD

The method and apparatus disclosed herein are related to the field of mobile communication, and, more particularly, but not exclusively to systems and methods for automatic assessment of driver's attention.

### CROSS-REFERENCE TO RELATED APPLICATIONS

This application claims priority from U.S. Provisional Patent Application Ser. No. 62/132,525 filed Mar. 13, 2015, entitled “Use of Motion Sensors on the Steering Wheel to Create Adaptive User Interface in the Car”, the disclosure of which is hereby incorporated by reference in its entirety.

This patent application is related to a co-owned PCT application, the disclosure of which is hereby incorporated by reference in its entirety, which is being filed same day and is entitled “SYSTEM AND METHOD FOR ADAPTING THE USER-INTERFACE TO THE USER ATTENTION AND DRIVING CONDITIONS”.

### BACKGROUND

Mobile communication is highly intrusive and requires attention in the most uncomfortable situations. In some situations, the interruption caused by mobile communication or mobile application may be dangerous, for example, while driving a car. There is thus a widely recognized need for, and it would be highly advantageous to have, a system and method for assessing driver's attention required by ambient conditions to affect the interaction of the user with a mobile device, devoid of the above limitations.

### SUMMARY OF THE INVENTION

According to one exemplary embodiment there is provided a method, a device, and a computer program including: defining a plurality of ambient conditions, associating a set of measurable ambient values for each of the ambient conditions, providing one or more rule for computing a user attention requirement value based on one or more of the measurable ambient values, measuring one or more of the ambient conditions to form a measured ambient value, and computing user attention requirement including one or more of the measured ambient values, using the one or more rule.

According to another exemplary embodiment there is provided a method, a device, and a computer program where the ambient condition includes one or more of: performance of a car, driving activity of a driver of a car, non-driving activity of a driver of a car, activity of a passenger in a car, activity of an apparatus in a car, road condition, off-road condition, roadside condition, traffic conditions, navigation, time of day, and weather.

According to yet another exemplary embodiment there is provided a method, a device, and a computer program where the step of measuring one or more of the ambient conditions includes using one or more data collection rule.

According to still another exemplary embodiment there is provided a method, a device, and a computer program additionally including the steps of: defining one or more driver's behavioral parameter, associating a set of measurable behavioral values for the one or more driver's behavioral parameter, measuring the one or more driver's behavioral parameter to form a measured behavioral value, and providing one or more rule for computing a user attention requirement value based on one or more of the measurable ambient values and the measured behavioral value.

Further according to another exemplary embodiment there is provided a method, a device, and a computer program where one or more driver's behavioral parameter includes one or more of history of the driver: driving a car being currently driven, driving a road being currently driven, operating a steering wheel, operating accelerator pedal, operating breaking pedal, operating gearbox, driving a car is in current road condition, off-road condition, roadside condition, driving a car is in current traffic conditions, driving a car is in current weather conditions, operating apparatus currently operated, and driving with a passenger currently in the car.

Yet further according to another exemplary embodiment there is provided a method, a device, and a computer program where the step of measuring one or more of the ambient conditions includes using one or more data collection rule, and where the data collection rule includes the measurable behavioral value, and/or the user attention requirement.

Still further according to another exemplary embodiment there is provided a method, a device, and a computer program additionally including: identifying a mobile application executing by a computing system, where the mobile application includes interaction with the driver, and where the step of measuring one or more of the ambient conditions includes using one or more data collection rule, and/or the step of computing user attention requirement including one or more of the measured ambient values, using the one or more rule, includes one or more of value associated with the mobile application.

Even further according to another exemplary embodiment there is provided a method, a device, and a computer program additionally assessing available attention of the user according to one or more measured behavioral values and the attention requirement value.

Additionally, according to another exemplary embodiment there is provided a method, a device, and a computer program for assessing user attention, including defining a plurality of ambient conditions, associating a set of measurable ambient values for each of the ambient conditions, providing at least one rule for computing a user attention requirement value based on at least one of the measurable ambient values, measuring an ambient conditions to form a measured ambient value, and computing user attention requirement based on a measured ambient value, using a rule for selecting a temporal sampling parameter and/or a temporal analysis parameter according to the attention requirement, and performing at least one of the steps of: measuring an ambient condition according to the temporal sampling parameter, and/or computing user attention requirement according to a temporal analysis parameter.

According to yet another exemplary embodiment there is provided a method, a device, and a computer program for assessing user attention where the temporal sampling parameter and/or the temporal analysis parameter include a time-period, and/or a repetition rate.

According to still another exemplary embodiment there is provided a method, a device, and a computer program for assessing user attention where the temporal sampling parameter and/or the temporal analysis parameter include a future time-period.

Further according to another exemplary embodiment there is provided a method, a device, and a computer program for assessing user attention where the future time-period includes a driver's relaxation period.

Still further according to another exemplary embodiment there is provided a method, a device, and a computer program for assessing user attention where measuring the ambient condition according to the temporal sampling parameter, and/or computing user attention requirement according to the temporal analysis parameter, include an expected event.

Yet further according to another exemplary embodiment there is provided a method, a device, and a computer program for assessing user attention where the expected event is associated with a mobile application.

Even further according to another exemplary embodiment there is provided a method, a device, and a computer program for assessing user attention where the expected event is derived from a navigation system.

Also, according to another exemplary embodiment there is provided a method, a device, and a computer program for assessing user attention additionally including: providing at least one measurement rule for measuring an ambient condition, and measuring an ambient conditions according to a measurement rule, where measuring the ambient conditions, and/or computing user attention requirement, modify the measuring rule.

According to still another exemplary embodiment there is provided a method, a device, and a computer program for assessing user attention where the modified measuring rule is different from the measuring rule, by invoking the measuring of the ambient conditions, and/or by invoking computing user attention requirement.

According to yet another exemplary embodiment there is provided a method, a device, and a computer program for assessing user attention where the modification includes modifying at least one of the temporal sampling parameter and the temporal analysis parameter.

Further according to another exemplary embodiment there is provided a method, a device, and a computer program for assessing user attention additionally including: providing at least one measurement rule for measuring an ambient conditions, and measuring at least one of the ambient conditions according to the measurement rule, where measuring the ambient conditions, and/or computing user attention requirement, modify the measuring rule, and where the modification includes modifying a temporal sampling parameter and/or modifying temporal analysis parameter, to form rule modification, and where the temporal sampling parameter and/or the temporal analysis parameter include a future time-period, and where the future time-period includes a driver's relaxation period, and where the rule modification includes modifying the relaxation period.

Unless otherwise defined, all technical and scientific terms used herein have the same meaning as commonly understood by one of ordinary skill in the relevant art. The materials, methods, and examples provided herein are illustrative only and not intended to be limiting. Except to the extent necessary or inherent in the processes themselves, no particular order to steps or stages of methods and processes described in this disclosure, including the figures, is intended or implied. In many cases the order of process steps may vary without changing the purpose or effect of the methods described.

### BRIEF DESCRIPTION OF THE DRAWINGS

Various embodiments are described herein, by way of example only, with reference to the accompanying drawings. With specific reference now to the drawings in detail, it is stressed that the particulars shown are by way of example and for purposes of illustrative discussion of the preferred embodiments only, and are presented in order to provide what is believed to be the most useful and readily understood description of the principles and conceptual aspects of the embodiment. In this regard, no attempt is made to show structural details of the embodiments in more detail than is necessary for a fundamental understanding of the subject matter, the description taken with the drawings making apparent to those skilled in the art how the several forms and structures may be embodied in practice.

In the drawings:

FIG. 1 is a simplified illustration of a driver attention assessment system;

FIG. 2 is a simplified block diagram of a computing system;

FIG. 3 is a block diagram of attention assessment system;

FIG. 4 is an illustration of a steering-wheel equipped with a steering-wheel sensor and sensor monitoring device;

FIG. 5 is a block diagram of attention assessment software;

FIG. 6 is a flow-chart of data-collection process;

FIG. 7 is a flow-chart of attention assessment process;

FIG. 8 is a flow-chart of a personal data collection process; and

FIG. 9 is a flow-chart of a running-integration attention-assessment process.

### DESCRIPTION OF THE PREFERRED EMBODIMENTS

The present embodiments comprise systems and methods for assessing driver's attention. The principles and operation of the devices and methods according to the several exemplary embodiments presented herein may be better understood with reference to the following drawings and accompanying description.

Before explaining at least one embodiment in detail, it is to be understood that the embodiments are not limited in its application to the details of construction and the arrangement of the components set forth in the following description or illustrated in the drawings. Other embodiments may be practiced or carried out in various ways. Also, it is to be understood that the phraseology and terminology employed herein is for the purpose of description and should not be regarded as limiting.

In this document, an element of a drawing that is not described within the scope of the drawing and is labeled with a numeral that has been described in a previous drawing has the same use and description as in the previous drawings. Similarly, an element that is identified in the text by a numeral that does not appear in the drawing described by the text, has the same use and description as in the previous drawings where it was described.

The drawings in this document may not be to any scale. Different Figs. may use different scales and different scales can be used even within the same drawing, for example different scales for different views of the same object or different scales for the two adjacent objects.

The purpose of the embodiments is to provide at least one system and/or method for assessing ambient conditions, and/or driver's activity, and/or driver's attention required by such ambient conditions, and/or by such driver's activity.

The term ‘car’ herein refers to any type of vehicle, and/or transportation equipment and/or platform, including fixed platforms such as cranes. The term “driver’ refers to a human operating any type of car as defined above. The term ‘passenger’ refers to any human other than the driver within the car as defined above.

The terms ‘ambience’ and/or ‘ambient’ as in ‘ambience-related’, ‘ambient sensor’ and ‘ambient condition’ refers to user's surrounding, and particularly to the state of the user's surroundings affecting the user and/or affected by the user. Particularly, the terms relates to the conditions outside the car (as defined above) and/or inside the car, and optionally and additionally, to any condition or situation affecting the car or the driver or requiring or affecting the attention of the driver of the car. In this respect the term ‘ambience’ and/or ‘ambient’ may refer to the car itself, or any of the car's components, and/or any condition or situation inside the car, and/or any condition or situation outside the car. Ambient conditions and/or situation outside the car may include, but are not limited to, the road, off-road, roadside, etc., and/or weather.

The terms ‘computing equipment’ and/or ‘computing system’ and/or ‘computing device’ and/or ‘computational system’ and/or ‘computational device’, etc. may refer to any type or combination of devices, or computing-related units, which are capable of executing any type of software program, including, but not limited to, a processing device, a memory device, a storage device, and/or a communication device.

The term ‘mobile device’ refers to any type of computational device installed and/or mounted and/or placed in the car, which may require and/or affect the attention of the driver. A mobile device may include components of the original car, after-market devices, and portable devices. Such a mobile device may not be mechanically connected to the car, such as a mobile telephone (smartphone) in the driver's pocket. Such mobile devices may include a mobile telephone and/or smartphone, a tablet computer, a laptop computer, a PDA, a speakerphone system installed in the car, the car entertainment system (e.g., radio, CD player, etc.), a radio communication device, etc. A mobile device is typically communicatively coupled to a communication network (as further defined below) and particularly to a wireless and/or cellular communication network.

The term ‘mobile application’ or simply ‘application’ refers to any type of software and/or computer program, which can be executed by a mobile device and interact with a driver and/or a passenger using any type of user interface. The term ‘executed’ may refer to the use, operation, processing, execution, installing, loading, etc., of any type of software program.

The term ‘network’ or ‘communication network’ refers to any type of communication medium, including but not limited to, a fixed (wire, cable) network, a wireless network, and/or a satellite network, a wide area network (WAN) fixed or wireless, including various types of cellular networks, a local area network (LAN) fixed or wireless, and a personal area network (PAN) fixed or wireless, and any may number of networks and combination of networks thereof, including, but not limited to, Wi-Fi, Bluetooth, NFC, etc.

The term ‘server’ or ‘communication server’ refers to any type of computing machine connected to a communication network and providing computing and/or software processing services to any number of terminal devices connected to the communication network.

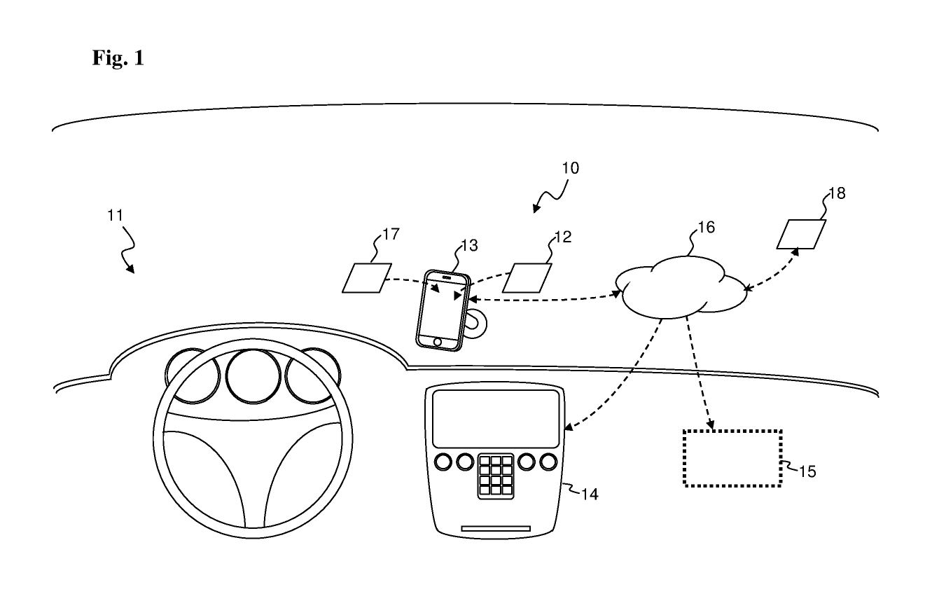

Reference is now made to FIG. 1, which is a simplified illustration of a driver attention assessment system 10, according to one exemplary embodiment.

FIG. 1 shows interior of a car 11 including a driver attention assessment system 10, which may include an attention assessment software program 12 executed by any computing equipment in a car. For example, attention assessment software 12 may be executed by a processor of a mobile communication device such as smartphone 13, a car entertainment system and/or speakerphone system 14, a car computer 15, etc.

The attention assessment software 12 may also communicate via, for example, communication network 16, with any other computing device in the car such as smartphone 13, car entertainment system and/or speakerphone system 14, a car computer 15, etc. For example, attention assessment software 12 may be executed by smartphone 13, and communicate with car entertainment system and/or speakerphone system 14, and with car computer 15.

The term ‘car computer’ or ‘car controller’ may refer to any type of computing device within the car that may provide information in real-time (other than the driver's mobile device such as smartphone 13). Such car computer of controller may include the engine management computer, the gearbox computer, etc.

It is appreciated that attention assessment software 12 may also communicate with a ‘car computer’ or ‘car controller’ involved in any type of car-to-car or car-to-road communication. Attention assessment software 12 may also assess the influence of such car-to-car communication on the driver and the amount of attention required by the driver, for example, when reacting to warnings issued responsive to such car-to-car or car-to-road communication.

The term ‘car entertainment system’ refers to any audio and/or video system installed in the car, including radio system, TV system, satellite system, speakerphone system for integrating with a mobile telephone, automotive navigation system, GPS device, reverse proximity notification system, reverse camera, dashboard camera, collision avoidance system, etc.

Smartphone 13 may also execute any number of mobile applications 17, and attention assessment software 12 may also communicate with any such mobile applications 17, either executed by the same smartphone 13 and/or by any other computational device in the car. For example, attention assessment software 12 may communicate with a navigation software executed by smartphone 13, and/or with a navigation device installed in the car, and/or with a navigation software executed by a smartphone of a passenger in the car.

Attention assessment software 12 may also communicate with one or more information services 18, typically external to the car. Attention assessment software 12 may communicate with such services, for example, via communication network 16. Such information services may be, for example, weather information service.

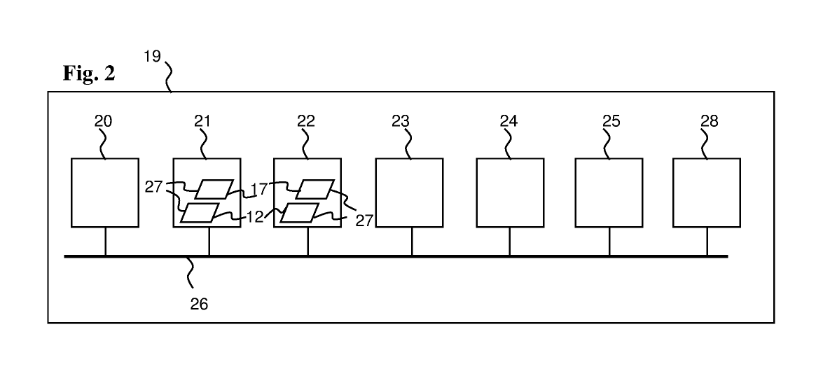

Reference is now made to FIG. 2, which is a simplified block diagram of a computing system 19, according to one exemplary embodiment. As an option, the block diagram of FIG. 2 may be viewed in the context of the details of the previous Figures. Of course, however, the block diagram of FIG. 2 may be viewed in the context of any desired environment. Further, the aforementioned definitions may equally apply to the description below.

Computing system 19 is a block diagram of a processing device used for executing a software program including, but not limited to, attention assessment software 12, and/or mobile application 17.

As shown in FIG. 2, computing system 19 may include at least one processor unit 20, one or more memory units 21 (e.g., random access memory (RAM), a non-volatile memory such as a Flash memory, etc.), one or more storage units 22 (e.g. including a hard disk drive and/or a removable storage drive, representing a floppy disk drive, a magnetic tape drive, a compact disk drive, a flash memory device, etc.).

Computing system 19 may also include one or more communication units 23, one or more graphic processors 24 and displays 25, and one or more communication buses 26 connecting the above units.

Computing system 19 may also include one or more computer programs 27, or computer control logic algorithms, which may be stored in any of the memory units 21 and/or storage units 22. Such computer programs, when executed, enable computing system 19 to perform various functions (e.g. as set forth in the context of FIG. 1, etc.). Memory units 21 and/or storage units 22 and/or any other storage are possible examples of tangible computer-readable media. Particularly, computer programs 27 may include attention assessment software 12, and/or mobile application 17 or parts, or combinations, thereof.

In the form, for example, of a processing device for executing attention assessment software 12, computing system 19 may also include one or more sensors 28. Sensors 28 are typically configured to sense ambient conditions, situations, and/or events.

In the form, for example, of a processing device for executing attention assessment software 12, communication units 23 may also be used to interface with various external resources using any type of communication network (such as for example, communication network 16 of FIG. 1). Such external resources may include, for example, smartphone 13, mobile application 17, car entertainment system and/or speakerphone system 14, a car computer 15, as well as external sensors for sensing ambient conditions. Such external resources may include, for example, one or more external services, such as a weather reporting website, and/or a navigation software, typically available via the Internet.

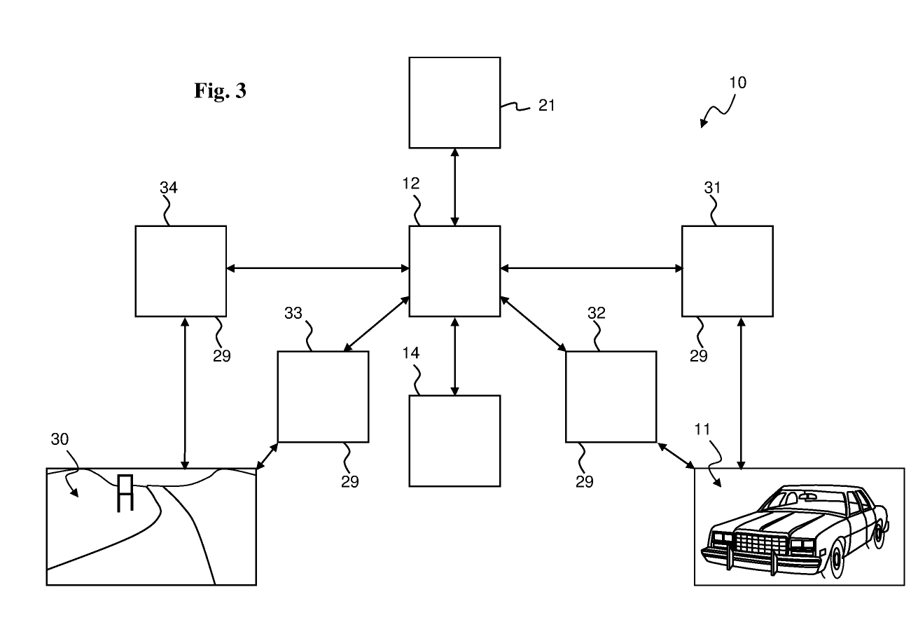

Reference is now made to FIG. 3, which is a block diagram of attention assessment system 10, according to one exemplary embodiment. As an option, the attention assessment system 10 of FIG. 3 may be viewed in the context of the details of the previous Figures. Of course, however, the attention assessment system 10 of FIG. 3 may be viewed in the context of any desired environment. Further, the aforementioned definitions may equally apply to the description below.

As shown in FIG. 3, attention assessment system 10 includes attention assessment software 12 communicatively coupled with mobile application 17, with various monitoring modules 29, and optionally also with the car speakerphone system or entertainment system 14.

The term ‘module’ may refer to a hardware module or device, or to a software module or process, typically executed by a corresponding hardware module or device. It is appreciated that any number of software module may be executed by any number of hardware module, such that one hardware module may execute more than one software modules, and/or that one software module may be executed by more than one hardware modules.

Monitoring modules 29 may include car monitoring modules that monitors the car's performance as well as the driver's activities operating the car 11, and ambient monitoring modules that monitor the ambient 30 outside and/or inside the car 11, and/or the surrounding of the driver, as well as the driver activities other than operating the car and passengers' activities.

Car monitoring modules may be embedded in the car 11 such as car computer or controller 31, or one or more car sensing modules 32 embedded in a mobile device such as the mobile device executing attention assessment software 12 (e.g., a smartphone). For example, a microphone, a camera, a GPS module, an accelerometer, an electronic compass, etc., typically embedded in a mobile telephone, typically operated by a respective software module, may serve as a car monitoring module. Additionally, car sensing modules 32 embedded in a mobile device such as the mobile device executing attention assessment software 12 may communicate with sensors mounted in the car 11.

Ambient monitoring modules may include or more ambient sensing modules 33 embedded in a mobile device such as the mobile device executing attention assessment software 12 (e.g., a smartphone). For example, a microphone, a camera a GPS module, an accelerometer, an electronic compass, etc., typically embedded in a mobile telephone, typically operated by a respective software module, may serve as an ambient monitoring module.

Ambient monitoring modules may also be an ambient sensing mobile application 34, such as a browser, accessing one or more external services, such as a weather reporting website, and/or a mapping software.

Ambient monitoring modules may also be, or communicate with, other applications operating in the car, such as a mapping software, and/or a navigation software, operating the mobile device executing attention assessment software 12, or executed by another device in the car.

It is appreciated that external information sources such as weather reporting website, mapping service, navigation software, etc., may provide forward-looking information. Such forward-looking information may enable attention assessment software 12 to anticipate future events potentially affecting, and/or requiring, the driver's attention. A weather service may inform the attention assessment software 12 of a rain, snow, or ice ahead of the car. A mapping service may inform the attention assessment software 12 of a junction, curve, bumps, etc., ahead of the car. Navigation software may provide the attention assessment software 12 estimated time of arrival at any localized situation ahead of the car as listed above. Additionally, navigation software may provide the attention assessment software 12 with the car planned route and anticipated driver's actions such as car turns. Therefore, ambient monitoring modules such as ambient sensing mobile application 34 may enable attention assessment software 12 to predict attention requirements, and/or to assess future attention requirements. Such future attention requirements may be provided as a sequence of time-related assessments, or a time-related function.

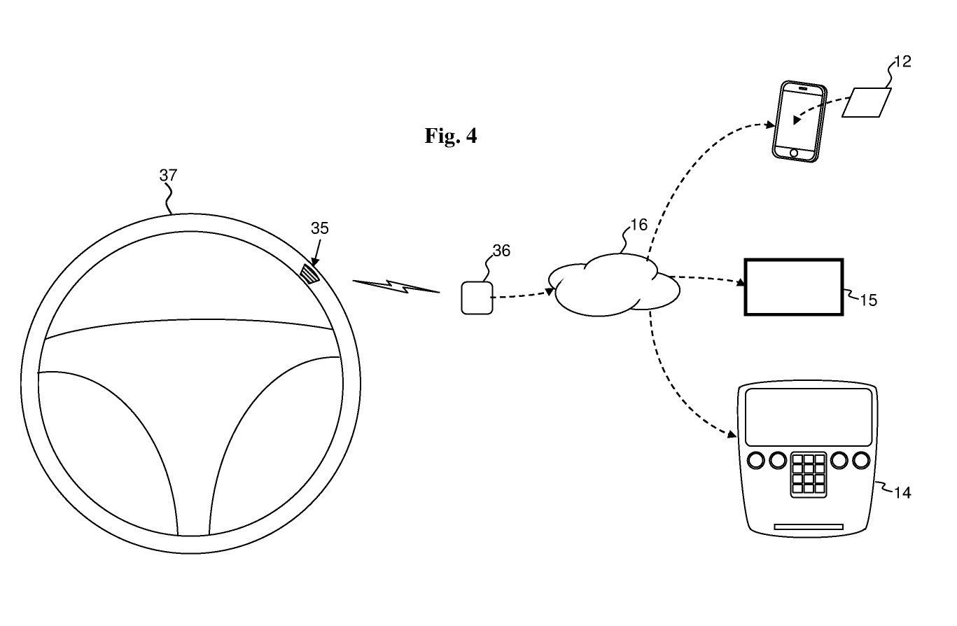

Reference is now made to FIG. 4, which is an illustration of steering-wheel equipped with a steering-wheel sensor 35 and sensor monitoring device 36, according to one exemplary embodiment. As an option, the illustration of FIG. 4 may be viewed in the context of the details of the previous Figures. Of course, however, the illustration of FIG. 4 may be viewed in the context of any desired environment. Further, the aforementioned definitions may equally apply to the description below.

Steering-wheel sensor 35 and/or sensor monitoring device 36 are provided herein as an example of a car sensing modules 32 of FIG. 3.

As shown in FIG. 4, a steering-wheel 37 is equipped with steering-wheel sensor 35, typically communicatively coupled to sensor monitoring device 36. Steering-wheel sensor 35 may be viewed as an exemplary embodiment of a car sensing module 32.

Further information regarding steering-wheel 37, steering-wheel sensor 35 and attention assessment software 12 may be found in U.S. Provisional Patent Application Ser. No. 62/132,525 filed Mar. 13, 2015, entitled “Use of Motion Sensors on the Steering Wheel to Create Adaptive User Interface in the Car”, the disclosure of which is hereby incorporated by reference.

Sensor monitoring device 36 may be communicatively coupled to car computer 15, car entertainment system and/or speakerphone system 14 and/or car computer or controller 31 (see FIG. 3), or directly to computing system 19 (see FIG. 2) executing attention assessment software 12. Sensor monitoring device 36 may be embedded in the car's dashboard or in any of car computer 15, car entertainment system and/or speakerphone system 14 and/or car computer or controller 31.

Steering-wheel sensor 35 may be any motion sensing device or positioning device such as an accelerometer, or a gyro, or both, or positioning device such as an encoder (e.g., rotary encoder, shaft encoder, position encoder, etc.) Steering-wheel sensor 35 may be mounted in the ring-handle of steering-wheel 37, or in the central hub, or on the steering, wheel shaft, etc. Steering-wheel sensor 35 may be communicatively coupled to a communication device such using any type of fixed or wireless communication technology such as USB, Bluetooth or ZigBee.

Steering-wheel sensor 35 and/or sensor monitoring device 36 measure and track the position, and/or movements and/or motions of the steering wheel, by the driver or any other cause, particularly, the direction, speed, acceleration, and range (travel or arc) of such motions.

Sensor monitoring device 36 may send steering wheel tracking information to the attention assessment software 12 in real-time. Sensor monitoring device 36 may send steering wheel tracking information to the attention assessment software 12 continuously. Alternatively, attention assessment software 12 may program sensor monitoring device 36 such steering wheel tracking information when any particular value such as rotation speed, acceleration, and/or range crosses a predefined threshold.

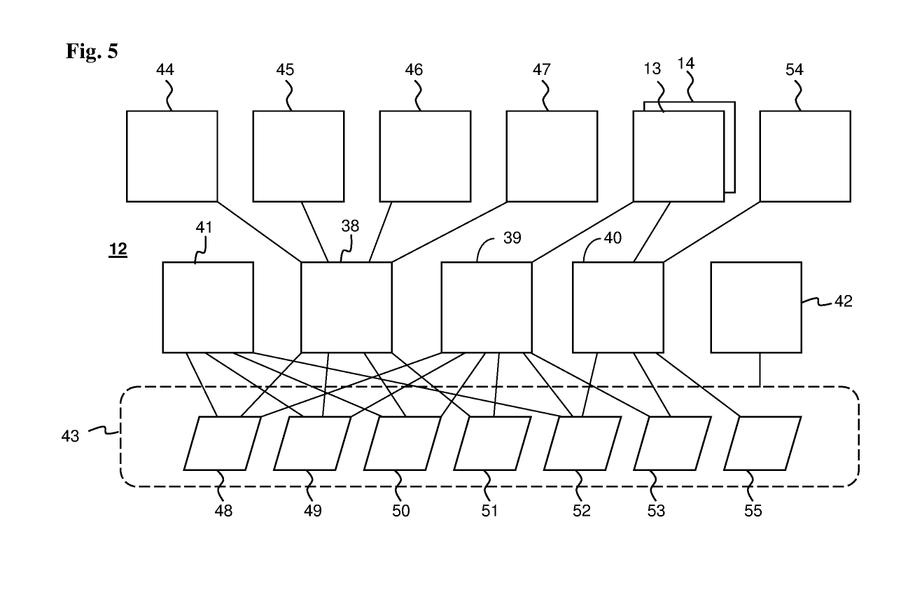

Reference is now made to FIG. 5, which is a block diagram of attention assessment software 12, according to one exemplary embodiment. As an option, the block diagram of attention assessment software 12 of FIG. 5 may be viewed in the context of the details of the previous Figures. Of course, however, the block diagram of the attention assessment system attention assessment software 12 of FIG. 5 may be viewed in the context of any desired environment. Further, the aforementioned definitions may equally apply to the description below.

As shown in FIG. 5, attention assessment software 12 may include the following main modules: a data collection module 38, an attention assessment module 39, a mobile interface module 40, an optional personalization module 41, an administration module 42, and database 43.

Data collection module 38 may be communicatively coupled to one or more interfacing modules such as car interface module 44, car sensing interface module 45, ambient sensing interface module 46 and ambient data collection module 47. Data collection module 38 may also be communicatively coupled via the Internet with any type of information providing service such as weather reports, traffic conditions, navigation information, etc.

Car interface module 44 may be communicatively coupled, for example, to car computer or controller 31 of FIG. 3. Car sensing interface module 45 may be communicatively coupled, for example, to car sensing modules 32 of FIG. 3. Ambient sensing interface module 46 may be communicatively coupled, for example, to ambient sensing modules 33 of FIG. 3. Ambient data collection module 47 may be communicatively coupled, for example, to ambient sensing mobile application 34 of FIG. 3.

Data collection module 38 may collect data received from the interfacing modules into database 43, and particularly to ambient data 48, car data 49, and personal data 50. Data collection module 38 may collect data according to data collection parameters and/or data collection rules 51.

Ambient data 48 may include current (present), past (historical), and/or future information about the ambient, or surroundings of the car and driver, such as:
The road, including road type and quality (including pavement quality).
Road surrounding and field of view.
Junction, curve, sign, and similar attention consuming characteristics of the road ahead of the car.
Traffic conditions, including traffic load and average speed.
Weather conditions such as temperature, wind, precipitation rate, type of precipitation, etc.
Time of day and road lighting conditions.

Traffic conditions may include actual conditions experienced at the time of operation, or estimated traffic based on the analysis of past traffic patterns at a specific time, day of week, time of year and location.

Weather conditions may include the driver's position and orientation with respect to the sun, as well as the sun elevation, at a specific time of day (e.g. assessing direct sunlight affecting visibility when the sun is low in front of the driver). Sunlight direction (horizontally and/or vertically) may also affect the visibility of any particular display, such as smartphone display and/or dashboard display, thus also affecting the driver's attention requirements.

Car data 49 may include current and past (historical) information about the car, such as speed, acceleration and/or deceleration, change of direction, noise level (including music, speech, and conversation, wind, etc.), steering wheel position, gear position and motion, breaking pedal status and motion, status of the car's lights, turn signals (including internal sound system), status of the windshield wiper system, status of the entertainment system (including status of the speakerphone system), etc.

Car data 49 may include actual or estimated operation of the car suspension system, distance from the car immediately ahead, presence and distance of the cars behind and on the sides etc. The car data 49 may also include static data about the car, such as type (passenger car, truck, bus, etc.), model, engine type and maximum power, transmission type, maximum speed, braking distance, maximum acceleration, etc.

Personal data 50 may include current and past (historical) information about the driver, such as the driver's age, gender, driving style, accident and near accident history, vision health, auditory health, general health conditions, history (acquaintance) with the particular car, with the particular road, with the particular road type, speed, weather conditions, etc.

Personal data 50 may also include details of the driver's behavior while driving, and particularly driving the car being currently driven, driving a road being currently driven, manner of operating a steering wheel, operating the accelerator pedal, operating the breaking pedal, operating the gearbox, driving a car is current road condition, off-road condition, roadside condition, driving a car is current traffic conditions, driving a car is current weather conditions, operating the mobile application 17 currently executing, and driving with the passenger currently in the car.

Any type of data collected by the data collection module 38 may be subject to one or more data collection parameters and/or rule 51. Data collection module 38 may use such data collection parameters or and/rules 51 to determine which data (e.g., ambient, car, and/or personal) should be collected, when to collect such data, how often to collect the data, etc.

Some of the collected data, and particularly ambient data, is forward looking. For example, road conditions and/or traffic conditions ahead of the car. Such forward looking data is collected for a particular distance or time-of-travel ahead of the car. Collection parameters and/or data collection rules 51 may indicate the required distance or time-of-travel is deter. The data collection module 38 uses such data collection rules and/or parameters to determine the forward looking data that should be collected. Such data collection rules and/or parameters may include ambient-related parameters such as road conditions, weather conditions, time of day, etc., car-related parameters such as speed, and personal parameters such as the driver's acquaintance with the road.

Collection parameters and/or data collection rules 51 may also apply to the analysis of some measurements taken by various sensors such as microphones, cameras, accelerometers, GPS systems, etc. For example, data collection rules 51 may compute a correlation between steering wheel position and change of direction to assess road condition.

Attention assessment module 39 may use collected data such as ambient data 48, car data 49, and personal data 50 as input data, and may output attention assessment data 52. Attention assessment module 39 may compute attention assessment data 52 based on attention assessment rules 53.

Data collection rules 51 may include temporal parameters such as sampling time (e.g., for the next sampling), sampling rate, sampling accuracy, notification threshold, etc. For example, sampling accuracy and/or notification threshold may determine the value of a change of a particular sampled and/or measured value for which a notification should be provided to the attention assessment module 39.

For example, a first data collection rule 51 measuring a first ambient condition (or car condition, etc.) may indicate that, upon a particular value sampled or measured for that first ambient condition, a particular change of one or more parameters, such as temporal parameters, of one or more other data collection rules 51.

Attention assessment rules 53 may also include temporal parameters, such as the rate of calculating attention requirements, and/or the period for which attention requirements are calculated. Such period for which attention requirements are calculated may include the past as well as the future. For example, such period may include driver's relaxation period in which, for example, an attention-related status, such as stress, may decay, following removal or decrease of the associated cause.

Attention assessment rules 53 may therefore also affect data collection rules 51, and particularly temporal parameters of data collection rules 51. For example, an attention assessment rule 53 may determine that if the driver attention is greater than a predefined threshold one or more data collection rules 51 should be executed more frequently, or report (notify) for a smaller change of the measured value, etc.

For example, an attention assessment rule 53 may determine that an external source such as weather information service, road traffic conditions, and/or navigation software, should be sampled at a higher rate, or for a smaller range or period, or reduce the period for which attention requirements are calculated, etc. For example, an attention assessment rule 53 may indicate that the navigation software should be sampled faster and for a shorter future (forward-looking) period.

Mobile interface module 40 may interface with the mobile device (smartphone) 13, and particularly with mobile application 17. Mobile interface module 40 may identify the particular mobile application 17 currently executing in the mobile device (smartphone) 13. Mobile device (smartphone) 13, may include a user-interface modification module that may be connected to the user-interface software of any number of mobile applications 54, and to any number of mobile devices (e.g., smartphone 13 of FIG. 1) and/or entertainment systems and/or speakerphone systems (e.g., element 14 of FIG. 1). Using UI modification rules 55, and attention assessment data 52, Mobile interface module 40 may modify the user interface of mobile application 17 to adapt to the changing user attention requirements.

Administration module 42 may enable a user and/or administrator to set preliminary or predetermined values for a variety of parameters, including rules, sampling periods, integration periods, etc. For example, Administration module 42 enables a user to define a plurality of ambient conditions, for example, by introducing and/or modifying or associating one or more measurable ambient values with each of the ambient conditions, and by defining at least one rule for computing a user attention requirement value based on one or more measurable ambient values.

Therefore, attention assessment system 10, and/or attention assessment software 12, may perform the following actions:

Enable a user to define a plurality of ambient conditions.

Enable a user to associate a set of measurable ambient values for each of the ambient conditions;

Enable a user to provide at least one rule for computing a user attention requirement value based one or more measurable ambient values.

Automatically and continuously and/or repeatedly perform measurements of the ambient conditions forming measured ambient values.

Automatically and continuously and/or repeatedly compute user attention requirement for the measured ambient values using the rules.

Automatically and continuously and/or repeatedly select at least one of temporal sampling parameter and temporal analysis parameter according to the attention requirement; and

Automatically and continuously and/or repeatedly perform one or more of the actions involving:
measuring at least one of the ambient conditions according to the temporal sampling parameter; and
computing user attention requirement according to the temporal analysis parameter.

It is appreciated that a temporal parameter may include a time period and that the time period may include a future time and/or an expected event. The expected event may be associated with an ambient condition, or with the car, or with an application executed by a mobile device, etc. Such expected event may affect the attention of the driver. For example, such expected event may be derived from a navigation system or software anticipating a driver's action or instructing a driver's action. For example, the expected event may by an instruction to the driver to make a turn.

Additionally, or optionally, attention assessment system 10, and/or attention assessment software 12, may also perform the following actions:

Enable a user to provide a measurement rule for measuring an ambient conditions, and automatically and continuously and/or repeatedly measure an ambient conditions according to the measurement rule. The action of measuring the ambient conditions, and/or the action of computing user attention requirement, may modifies the measuring rule, for example by modifying a parameter of the measuring rule, for example by modifying a temporal parameter.

It is appreciated that a modified measuring rule may invoke measuring one or more other ambient conditions, for example by invoking a measurement rule, for example by modifying a parameter of the measurement rule. It is appreciated that a modified measuring rule may also invoke computing attention assessment, for example by invoking an attention analysis rule. For example by modifying a parameter of an attention analysis rule. For example by modifying a temporal parameter.

It is appreciated that attention assessment system 10, and/or attention assessment software 12, may also perform these actions where the measuring of an ambient conditions, and/or the computing of user attention requirement, may modify the measuring rule. Such modification may change a temporal sampling parameter and/or a temporal analysis parameter. Such temporal sampling parameter and/or temporal analysis parameter may include a future time-period, which may include a driver's relaxation period. Such rule modification may include modifying the relaxation period.

Reference is now made to FIG. 6, which is a flow-chart of data-collection process 56, according to one exemplary embodiment.

As an option, the flow-chart of data-collection process 56 of FIG. 6 may be viewed in the context of the details of the previous Figures. Of course, however, the flow-chart of data-collection process 56 of FIG. 6 may be viewed in the context of any desired environment. Further, the aforementioned definitions may equally apply to the description below. For example, data-collection process 56 may be executed by data collection module 38 of FIG. 5.

As shown in FIG. 6, data-collection process 56 may start with step 57 by receiving a particular data from any one of a plurality of data sources such as car data or ambient data that pay be provided by any of car computer or controller 31, car sensing modules 32, ambient sensing modules 33, and/or sensing mobile application 34.

Data-collection process 56 may proceed to step 58 to store the collected data in database 43, and particularly in the relevant database such as ambient data 48 and/or car data 49.

Data-collection process 56 may then proceed to step 59 to load from database 43 (e.g., a rule that applies to the received data). Data-collection process 56 may then proceed to step 60 to interrogate one or more data sources according to the particular rule loaded in step 59. The data collection rules may include a temporal parameter, such as a sampling parameter, indicating the time, or time period, or sampling frequency, etc.

Data-collection process 56 may repeat steps 59 and 60 until all the relevant rules are processed (step 61).

Based on a data collection rule, data-collection process 56 may proceed to step 62 to notify attention assessment module 39 of FIG. 5 that the collected data justifies and/or requires processing attention assessment.

Data-collection process 56 may then modify collection parameters (step 63) if needed, for the same rule or for any other data collection rule. Particularly, step 63 may select a temporal sampling parameter indicating the sampling time, or sampling period, or sampling frequency, etc. Such temporal sampling parameter may include future time and/or expected events. It is appreciated that expected events may be associated, or derived from, or created by, a mobile device or a mobile application, from example, a navigation system indicating a future turn.

Data-collection process 56 may then wait (step 64) for more data, either data which communication is initiated by the sending side (e.g., car computer), and/or scheduled measurements.

In step 60, data-collection process 56 may use the rule loaded in step 59 to execute and/or to schedule the execution of any other measurement and/or query of any type of data (e.g., ambient data) from any data source such as car data or ambient data that pay be provided by any of car computer or controller 31, car sensing modules 32, ambient sensing modules 33, and/or sensing mobile application 34.

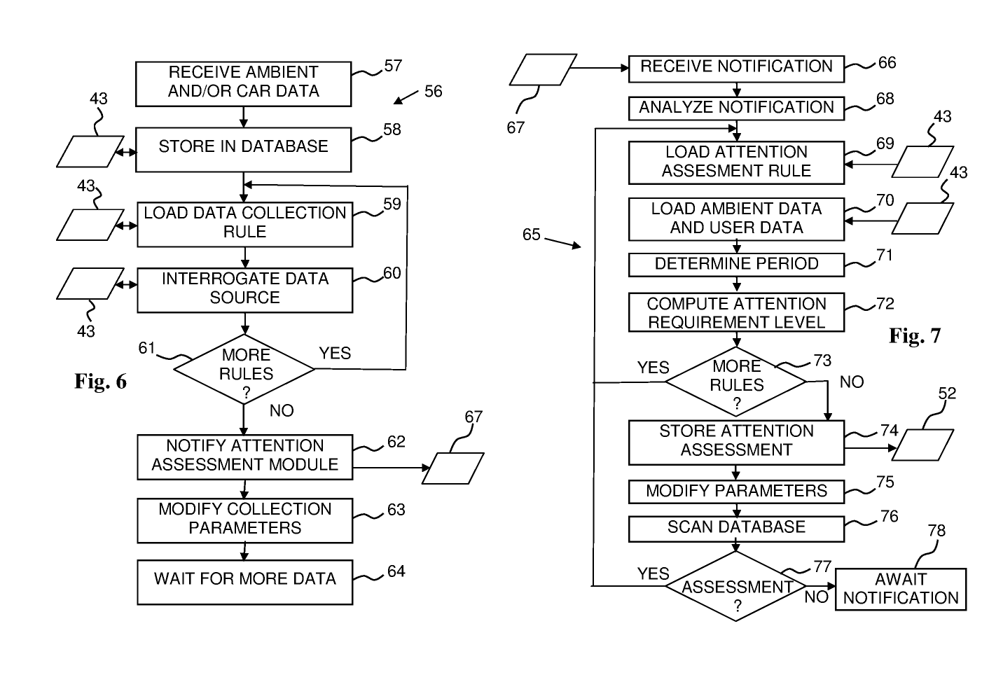

Reference is now made to FIG. 7, which is a flow-chart of attention assessment process 65, according to one exemplary embodiment.

As an option, the flow-chart of attention assessment process 65 of FIG. 7 may be viewed in the context of the details of the previous Figures. Of course, however, the flow-chart of attention assessment process 65 of FIG. 7 may be viewed in the context of any desired environment. Further, the aforementioned definitions may equally apply to the description below. For example, flow-chart of attention assessment process 65 may be executed by attention assessment module 39 of FIG. 5.

Attention assessment module 39, and/or attention assessment process 65, may be executed continuously, or may be invoked periodically based on one or more predefined parameters (e.g. once every 5 sec), and/or dynamically based on rules and ambient conditions data.

Attention assessment module 39, and/or attention assessment process 65, may determine the attention assessment data 52 according to one or more of the following exemplary scenarios:

The attention assessment data is determined in the rage from 0 (e.g., no attention is needed, i.e. the car is parked and the engine is off) to 100% (maximum attention is needed, i.e. any additional distraction is prohibited)

On each invocation, the system iterates through the attention assessment rules 53. Each attention rule translates the ambient data 48, car data 49, and/or personal data 50 into an attention factor on the scale between 0 and 100%.

The system then adds all the attention factors, which together define the attention assessment data 52 as a moving average across an averaging window.

The averaging window is dynamic and depends on the speed of the vehicle. Higher the speed, shorter the averaging window.

Attention assessment data 52 above 100% is possible and represents conditions where the driver is driving in a dangerous manner (e.g. with a probability of accident above certain threshold.) In this case the system may issue a warning to the driver.

For example, as shown in FIG. 7, attention assessment process 65 may start with step 66, for example when an assessment notification 67 is received from data-collection process 56. Attention assessment process 65 may then proceed to step 68 to analyze the reason for the notification, such as a change in ambient or car data that justifies and/or requires attention assessment and/or update. Such reason typically results from a change of one or more types of ambient or car data surpassing a particular predetermined threshold.

However, some analysis may be more sophisticated. For example, the analysis module may analyze the sound picked up by a microphone in the car, such as the microphone of smartphone 13, to detect and/or characterize particular sounds.

For example, to detect the sound associated with the turning indicator light (also known as ‘direction indicators’) to determine the driver's intention to turn before the driver rotates the steering wheel and/or before the car turns. For example, the analysis module can detect human voices in the car to identify the passengers, and thus to characterize the attention load on the driver. For example, the analysis module can detect a row, a baby crying, etc. For example, the analysis module can detect an outside noise such as the siren of a first responder car (e.g., police patrol car, ambulance, fire brigade unit, etc.)

Attention assessment process 65 may then proceed to step 69 to load an attention assessment rule that is relevant to the notification reason (e.g., according to the particular one or more ambient or car data surpassing the threshold).

Attention assessment process 65 may then proceed to step 70 to load other ambient data, and/or car data, and/or personal data, as required by the particular attention assessment rule loaded in step 69.

Attention assessment process 65 may then proceed to step 71 to determine an assessment period. The assessment period refers to the time period for which collected data (e.g., ambient data, car data, user data, etc.) should be considered. This period may include past (history) data and/or future (anticipated) data. Such future data may be collected from internal and/or external sources, including weather information sources, traffic condition sources, a navigation system, etc. In step 71 attention assessment process 65 the scope and/or time-frame and/or period for which the rule, or a particular type of measurements should be calculated. Such time period may also include the relaxation period for the particular driver, for which a particular level or type of attention may persist, or decay. Assessment period as determined in step 71 may be based on a temporal sampling parameter of the relevant assessment rule.

Attention assessment process 65 may then proceed to step 72, and, using the loaded attention assessment rule, compute an attention requirement level. Step 72 may therefore compute user attention requirement level according to collected data as indicated by the relevant rule. Such collected data may span a period of time as indicated by step 71, for example, according to temporal sampling parameter included in the relevant rule. Such temporal parameter may include future time, and/or expected events.

When all relevant attention assessment rules are processed (step 73), and Attention assessment process 65 may then proceed to step 74 to store the updated attention assessment in attention assessment data 52 of FIG. 5.

Attention assessment process 65 may then proceed to step 75 to modify any other rules, including attention assessment rules and/or data collection rules. Such modification may be performed by modifying one or more parameters of such rules, for example by modifying temporal parameters, for example by modifying a relevant time period.

It is appreciated that such temporal parameters of a data collection rule and/or attention assessment rule may by modified or selected according to the computed user attention requirement. It is appreciated that such temporal parameters may include a relaxation period such as user attention requirement relaxation period.

Attention assessment process 65 may then proceed to step 76 to scan the ambient or car data according to further attention assessment rules to detect situations requiring further attention assessment, and, if no such situation is detected (step 77), to wait (step 78) for the next notification 67 from data-collection process 56.

It is appreciated that attention assessment, such as performed in step 72, for example as determined by a particular attention assessment rule, may associate the particular attention requirement with one or more sensory faculties or modalities. For example, attention assessment process 65 may determine that a particular sensory faculty of the driver is loaded to a particular level. For example, the visual faculty, and/or the auditory faculty, and/or the manual faculty. In other words, attention assessment process 65 may associate different levels of attention requirement with each sensory faculty of the driver.

It is appreciated that driver attention assessment system 10, and particularly software programs 56 and 65 may assess the attention load, or attention requirement as applicable to a driver of a car, by performing the following actions:

Enable a user to define one or more ambient conditions. The term ambient condition here may include condition or performance associated with the car, condition or situation external to the car such as the road and the environment, and condition or situation associated with the driver (other than driving the car) including historical and statistical data.

Enable a user to define and/or associate at least one measurable ambient value for each of the ambient conditions. Typically the user may define a set of measurable ambient value associated with respective levels of the measured ambient condition.

Enable a user to define and/or provide at least one attention assessment rule for computing a user attention requirement value based on at least one of the measurable ambient values. Such rule may be, for example, a formula in which the measured ambient condition is a parameter.

Measure at least one of the ambient conditions to form a measured ambient value.

Compute the user attention required by any one of the measured ambient conditions or any combination of ambient conditions using at least one of the attention assessment rules and respective measured ambient values.

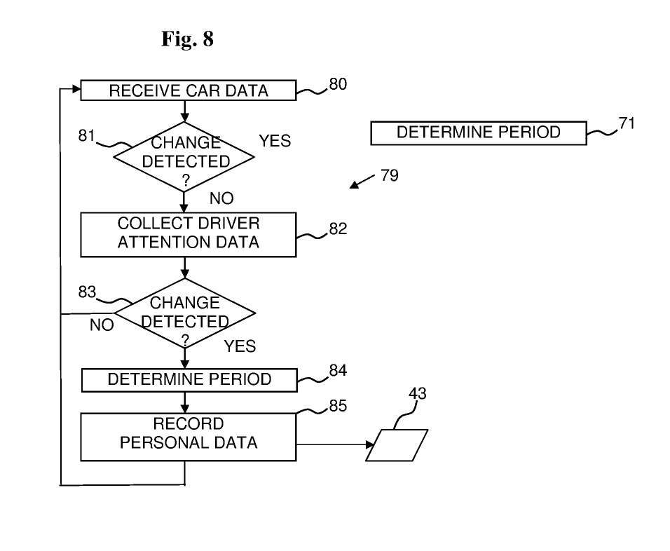

Reference is now made to FIG. 8, which is a flow-chart of a personal data collection process 79, according to one exemplary embodiment.

As an option, the flow chart of personal data collection process 79 of FIG. 8 may be viewed in the context of the details of the previous Figures. Of course, however, the flow-chart of FIG. 8 may be viewed in the context of any desired environment. Further, the aforementioned definitions may equally apply to the description below.

As described above, attention assessment process 65 compute the attention load and/or requirement on the driver according to the collected ambient data and car data, and according to personal data collected for the particular data. The personal data includes, but is not limited to, the history of the driver operating the particular car, or a similar car, in the same, or similar ambient conditions. Such ambient conditions may be the particular road, or road type, the current traffic conditions, weather conditions and/or time-of-day, etc. Personal data collection process 79 collects such personal data.

For example, personal data collection process 79 may be executed as part of personalization module 41 of FIG. 5. For example, personal data collection process 79 may compute personal data 50 by correlating ambient data 48 and/or car data 49 with attention assessment data 52, therefore analyzing the sensitivity of a particular data to particular events such as ambient-related, and/or car-related events.

As shown in FIG. 8, Personal data collection process 79 may start with step 80 by receiving one or more measurements of one or more ambient conditions or car condition and/or performance.

Personal data collection process 79 may then check (step 81) if the received measurement value indicates a change of the measured condition, for example by comparing the received value with a predetermined threshold, or by comparing the difference between the received value and a running average (for example, and average of the measurement values over a predetermined period) with a predetermined threshold.

Personal data collection process 79 may then proceed to step 82 to collect driver attention data.

Personal data collection process 79 may then check (step 83) if the received driver attention data has changed, for example by comparing the received value with a predetermined threshold, or by comparing the difference between the received value and a running average (for example, and average of the measurement values over a predetermined period) with a predetermined threshold.

If such change is detected the personal data collection process 79 may then proceed to step 84 to determine a period for which the particular data, or change of data, or condition, is valid, or requires recalculation or reassessment. For example, the period may determine the rate of relaxation of a particular condition following a particular event causing the condition.

Personal data collection process 79 may then proceed to step 85 to store the event in database 43 and/or in personal data 50, including the driver attention data, the car data and the ambient data at the particular time of record.

The driver's attention can be measured as a value within a range, for example, a number between 1 and 100. Attention assessment value of 65 may mean that the available attention is 35 or less, as an upper boundary may be set, for example, on a personal level. The assessed available attention may then be used to control the attention requirement by, for example, the mobile application.

Alternatively or additionally, the driver's attention can be measured as a set of values, where each value indicating a different aspect of attention (attention faculty). For example, the attention requirements may be divided into visual attention, audible attention, haptic attention, cognitive attention, attention associated with orientation, etc.

Additionally, and optionally, a measure of attention sensitivity may be set, for example, on a personal level. Attention sensitivity may take the form of a quantum change of the attention assessment value. Attention sensitivity of less sensitive drivers may have a change value of 1 while more sensitive drivers may have a higher change value, such as 10. Therefore when the attention assessment value for a less sensitive driver is, for example, increased, it can be increased by multiples of 1, while the increase for the more sensitive driver will be in multiples of 10.

Additionally, and optionally, a measure of attention relaxation period may be set, for example, on a personal level. Therefore, when the attention assessment value for a less sensitive driver is, for example, decreased, it can be decreased faster than for the more sensitive driver.

The computing of the attention assessment value may use a formula including variables for the measured ambient data and car data, and personal parameters such as the change quantum, sensitivity, relaxation period, etc. For example, whenever s measured ambient data and car data is change, and/or periodically, the attention assessment engine (e.g., step 72 of FIG. 7) recalculates the formula to provide an updated attention assessment value.

For example, attention assessment process 65 of FIG. 7 may use a single formula for computing the attention assessment value, or may have a plurality of such formulas. For example, there may be a formula for each attention faculty. Therefore, for example, traffic conditions may have a different effect on visual and audible faculties.

Additionally, and optionally, attention assessment process 65 of FIG. 7, and particularly the attention assessment engine (e.g., step 72) may use a measure of cross-correlation between such formulas and/or attention faculties. For example, a cross-correlation value may be set for the upper limit value for each attention faculty. Therefore, for example, for a particular driver, if only the visual attention is loaded by 60 (of 100) the available attention is 40. However, if the audible and haptic attention faculties are also loaded, for example by 20 (of 100), then the upper limit of the visual attention faculty is reduced, for example, to 80. Thus the available visual attention is reduced to 20 (80 minus 60). Therefore, driver attention assessment system 10 may enable a user to define at least one ambient condition, associate at least one measurable ambient value for each ambient condition, and provide at least one rule for computing a user attention requirement value based on at least one of measurable ambient value. Using such rules, the driver attention assessment system 10 may then measure such ambient values and compute, in real-time, the user attention requirement according to the measured ambient values.

Driver attention assessment system 10 may enable a user to define at least one driver's behavioral parameter, associate at least one measurable behavioral value for each driver's behavioral parameter, and provide at least one rule for computing a user attention requirement value based on the measurable ambient values and the measurable behavioral value. Using these rules, the driver attention assessment system 10 may then measure such driver's behavioral parameters and compute, in real-time, the user attention requirement according to the measured ambient values and the measured behavioral value.

The ambient conditions may include the performance of a car, driving activity of a driver of a car, non-driving activity of a driver of a car, activity of a passenger in a car, activity of an apparatus in a car, road condition, off-road condition, roadside condition, traffic conditions, navigation information, time of day, and weather conditions.

The driver's behavioral parameters may include: history driving the car being currently driven, history driving a road being currently driven, manner of operating the steering wheel, accelerator pedal, breaking pedal and/or gearbox, history of driving the car in current road condition, off-road condition, roadside condition, current traffic conditions, current weather conditions, manner of operating the mobile application 17 currently executing, and history of driving with the passengers currently in the car.

As shown in the flow-chart of FIG. 7, attention assessment process 65 is invoked in step 66 by a notification from data-collection process 56, when data-collection process 56 determines, based on a data collection rule, that a new data collected requires attention assessment. Alternatively, or additionally, attention assessment process 65 may be invoked periodically. For example, a clock may be set for a predetermined or calculated period and invoke step 66. Such period may be calculated, and the clock may be set, in step 78 of FIG. 7.

Alternatively, or additionally, attention assessment process 65 may compute a running integration of the attention requirement. The term ‘running integration’ refers to a value computed over a period of time preceding the time of calculation. In this manner, a clock invokes attention assessment process 65 periodically. For example, the clock may be set in step 78 of FIG. 7 invoking attention assessment process 65 in step 66. It is appreciated that the integration period may be different from the clock repetition period. Typically, the integration period is larger than the clock repetition period. A typical running integration value is a running average, however, other algorithms are contemplated, such as time-weighted averaging.

It is therefore appreciated that attention requirement value may be computed over a recent period (e.g., running integration), and/or instantaneously (e.g., without any integration over time). It is appreciated that attention requirement may be assessed both instantaneously and a plurality of running integration algorithms to characterize the driver's behavior (e.g., personal data) and traffic conditions (e.g., ambient data).

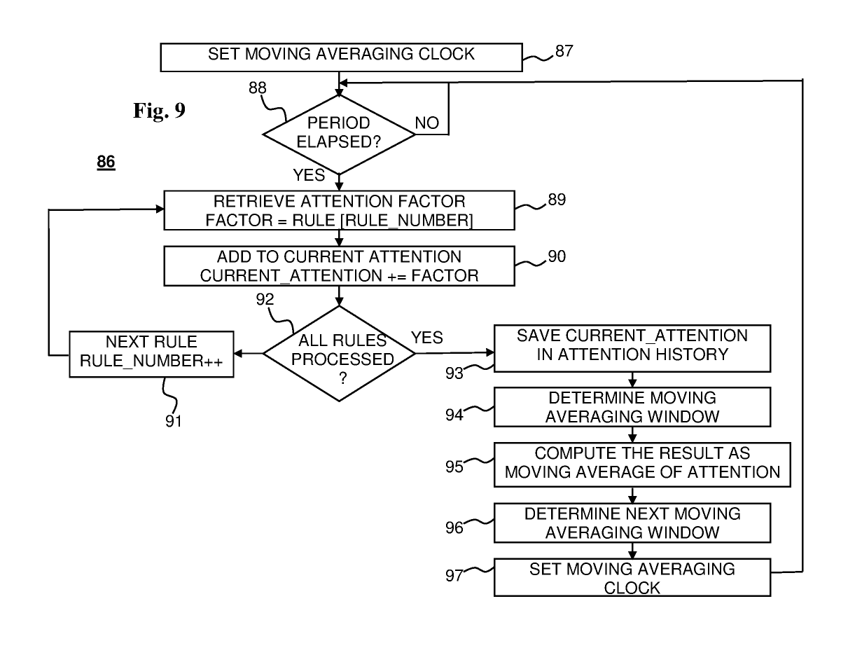

Reference is now made to FIG. 9, which is a flow-chart of a running-integration attention-assessment process 86, according to one exemplary embodiment.

As an option, the attention-assessment process 86 of FIG. 9 may be viewed in the context of the details of the previous Figures. Of course, however, the attention-assessment process 86 of FIG. 9 may be viewed in the context of any desired environment. Further, the aforementioned definitions may equally apply to the description below.

As shown in FIG. 9, running-integration attention-assessment process 86 may start with step 87 by setting a clock to the required integration period. The required integration (or averaging) period may be determined on a personal (driver) level and may be retrieved from database 43. This may be an initial integration period as the time period may change according to the situation (e.g., attention level). In step 88 the clock may then trigger the running-integration attention-assessment process 86 periodically.

Running-integration attention-assessment process 86 may then proceed to steps 89 and 90 to compute attention factor according to a particular rule and repeat steps 89 and 90 (e.g., step 91) until all rules are processed (step 92).

Running-integration attention-assessment process 86 may then proceed to step 93 to store the current attention value (e.g., in database 43), to determine the current moving integration period (step 94) and to compute the integrated (e.g., averaged) attention requirement value for the current period (step 95).

Running-integration attention-assessment process 86 may then proceed to step 96 to calculate the next integration period and to set the integration clock accordingly (step 97).

It is appreciated that certain features, which are, for clarity, described in the context of separate embodiments, may also be provided in combination in a single embodiment. Conversely, various features, which are, for brevity, described in the context of a single embodiment, may also be provided separately or in any suitable sub-combination.

Although descriptions have been provided above in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art.

What is claimed is:

1. A method for assessing user attention, the method comprising:
defining a plurality of ambient conditions;
associating a set of measurable ambient values for each of said ambient conditions;
providing at least one rule for computing a user attention requirement value based on at least one of said measurable ambient values;
measuring at least one of said ambient conditions to form a measured ambient value; and
computing user attention requirement comprising at least one of said measured ambient values, using said at least one rule;
selecting at least one of temporal sampling parameter and temporal analysis parameter according to said attention requirement; and
performing at least one of said steps of:
measuring at least one of said ambient conditions according to said temporal sampling parameter; and
computing user attention requirement according to said temporal analysis parameter.

2. The method of claim 1 wherein said at least one temporal sampling parameter and temporal analysis parameter comprises a time-period, and a repetition rate.

3. The method of claim 1 wherein said at least one temporal sampling parameter and temporal analysis parameter comprises a future time-period.

4. The method of claim 3 wherein said future time-period comprises a driver's relaxation period.

5. The method of claim 1 wherein at least one said measuring at least one of said ambient conditions according to said temporal sampling parameter, and said computing user attention requirement according to said temporal analysis parameter, comprises an expected event.

6. The method of claim 5 wherein said expected event is associated with a mobile application.

7. The method of claim 5 wherein said expected event is derived from a navigation system.

8. The method of claim 1 additionally comprising:
providing at least one measurement rule for measuring said at least one of said ambient conditions; and
measuring at least one of said ambient conditions according to said measurement rule;
wherein at least one of: said measuring at least one of said ambient conditions, and said computing user attention requirement, modifies said measuring rule.

9. The method of claim 8 wherein said modified measuring rule is different from said measuring rule, by invoking said at least one of: said measuring at least one of said ambient conditions, and said computing user attention requirement.

10. The method of claim 8 wherein said modification comprises modifying at least one of said temporal sampling parameter and said temporal analysis parameter.

11. The method of claim 1 additionally comprising:
providing at least one measurement rule for measuring said at least one of said ambient conditions; and
measuring at least one of said ambient conditions according to said measurement rule;
wherein at least one of: said measuring at least one of said ambient conditions, and said computing user attention requirement, modifies said measuring rule;
wherein said modification comprises modifying at least one of said temporal sampling parameter and said temporal analysis parameter to form rule modification;
wherein said at least one temporal sampling parameter and temporal analysis parameter comprises a future time-period;
wherein said future time-period comprises a driver's relaxation period; and
wherein said rule modification comprises modifying said relaxation period.

12. A system for assessing user attention, the system comprising:
a user interface unit configured to enable a user to:
define a plurality of ambient conditions;
associate a set of measurable ambient values with each of said ambient conditions; and
provide at least one rule for computing a user attention requirement value based on at least one of said measurable ambient values;
an ambient measuring unit configured to measure at least one of said ambient conditions to form a measured ambient value according to at least one temporal sampling parameter; and
an attention assessment unit configured to compute user attention requirement comprising at least one of said measured ambient values, and using said at least one rule using at least one temporal analysis parameter;
wherein said at least one of temporal sampling parameter and temporal analysis parameter is selected according to said computed user attention requirement.

13. The system according to claim 12 wherein said at least one temporal sampling parameter and temporal analysis parameter comprises a time-period, and a repetition rate.

14. The system according to claim 12 wherein said at least one temporal sampling parameter and temporal analysis parameter comprises a future time-period.

15. The system according to claim 14 wherein said future time-period comprises a driver's relaxation period.

16. The system according to claim 12 wherein at least one of:
said ambient measuring unit is configured to measure at least one expected event; and
said attention assessment unit is configured to compute user attention requirement according to at least one expected event.

17. The system according to claim 16 wherein said expected event is associated with a mobile application.

18. The system according to claim 16 wherein said expected event is derived from a navigation system.

19. The system according to claim 12 wherein:
said user interface unit additionally configured to enable a user to provide at least one measurement rule for measuring said at least one of said ambient conditions; and
said ambient measuring unit is additionally configured to measure at least one of said ambient conditions according to said measurement rule;
wherein at least one of:
said ambient measuring unit is additionally configured to modify said measuring rule according to a result of said measurement; and
said attention assessment unit is additionally configured to modify said measuring rule according to said computed user attention requirement.

20. The system according to 19 wherein said modified measuring rule is different from said measuring rule, by invoking said at least one of: said measuring at least one of said ambient conditions, and said computing user attention requirement.

21. The system according to 19 wherein said modification comprises modifying at least one of said temporal sampling parameter and said temporal analysis parameter.

22. The system according to claim 12 additionally comprising:
said user interface unit additionally configured to enable a user to provide at least one measurement rule for measuring said at least one of said ambient conditions; and
said an ambient measuring unit additionally configured to measure at least one of said ambient conditions according to said measurement rule;
wherein at least one of:
said measuring at least one of said ambient conditions, and said computing user attention requirement, modifies said measuring rule;
wherein at least one of:
said ambient measuring unit is additionally configured to modify said measuring rule according to a result of said measurement; and
said attention assessment unit is additionally configured to modify said measuring rule according to said computed user attention requirement
wherein said modification comprises modifying at least one temporal sampling parameter and temporal analysis parameter;
wherein said at least one temporal sampling parameter and temporal analysis parameter comprises a future time-period;
wherein said future time-period comprises a driver's relaxation period; and
wherein said rule modification comprises modifying said relaxation period.

23. A non-transitory computer readable medium include instructions that, when executed by at least one processor, cause the at least one processor to perform operations comprising:
defining a plurality of ambient conditions;
associating a set of measurable ambient values for each of said ambient conditions;
providing at least one rule for computing a user attention requirement value based on at least one of said measurable ambient values;
measuring at least one of said ambient conditions to form a measured ambient value; and
computing user attention requirement comprising at least one of said measured ambient values, using said at least one rule;
selecting at least one of temporal sampling parameter and temporal analysis parameter according to said attention requirement; and
performing at least one of said steps of:
measuring at least one of said ambient conditions according to said temporal sampling parameter; and
computing user attention requirement according to said temporal analysis parameter.

24. The instructions according to claim 23 wherein said at least one temporal sampling parameter and temporal analysis parameter comprises a time-period, and a repetition rate.

25. The instructions according to claim 23 wherein said at least one temporal sampling parameter and temporal analysis parameter comprises a future time-period.

26. The instructions according to claim 25 wherein said future time-period comprises a driver's relaxation period.

27. The instructions according to claim 23 wherein at least one said measuring at least one of said ambient conditions according to said temporal sampling parameter, and said computing user attention requirement according to said temporal analysis parameter, comprises an expected event.

28. The instructions according to claim 19 wherein said expected event is associated with a mobile application.

29. The instructions according to claim 19 wherein said expected event is derived from a navigation system.

30. The instructions according to claim 23 additionally comprising:
providing at least one measurement rule for measuring said at least one of said ambient conditions; and
measuring at least one of said ambient conditions according to said measurement rule;
wherein at least one of: said measuring at least one of said ambient conditions, and said computing user attention requirement, modifies said measuring rule.

31. The instructions according to claim 30 wherein said modified measuring rule is different from said measuring rule, by invoking said at least one of: said measuring at least one of said ambient conditions, and said computing user attention requirement.

32. The instructions according to claim 30 wherein said modification comprises modifying at least one of said temporal sampling parameter and said temporal analysis parameter.

33. The instructions according to claim 23 additionally comprising:
providing at least one measurement rule for measuring said at least one of said ambient conditions; and
measuring at least one of said ambient conditions according to said measurement rule;
wherein at least one of: said measuring at least one of said ambient conditions, and said computing user attention requirement, modifies said measuring rule;
wherein said modification comprises modifying at least one of said temporal sampling parameter and said temporal analysis parameter to form rule modification;
wherein said at least one temporal sampling parameter and temporal analysis parameter comprises a future time-period;
wherein said future time-period comprises a driver's relaxation period; and
wherein said rule modification comprises modifying said relaxation period.
